(19) United States
(12) Patent Application Publication
(10) Pub. No.: US 2024/0401979 A1
(43) Pub. Date: Dec. 5, 2024

(54) GYRO GAIN SEARCH METHOD AND APPARATUS, ELECTRONIC DEVICE, AND STORAGE MEDIUM

(71) Applicant: AAC Acoustic Technologies (Shanghai) Co., Ltd., Shanghai (CN)

(72) Inventors: Zheng Xiang, Shanghai (CN); Guangyun Han, Shanghai (CN); Yan Zhang, Shanghai (CN); Tingkai Gu, Shanghai (CN)

(21) Appl. No.: 18/408,443

(22) Filed: Jan. 9, 2024

Related U.S. Application Data
(63) Continuation of application No. PCT/CN2023/101327, filed on Jun. 20, 2023.

(30) Foreign Application Priority Data
Jun. 5, 2023 (CN) 202310659146.6

(51) Int. Cl. G01C 25/00; H04N 23/68

(52) U.S. Cl. CPC G01C 25/005; H04N 23/685

(57) ABSTRACT

A gyro gain search method and apparatus, an electronic device and a storage medium. The method includes: searching for gyro gains within a first search range according to a first search step size to obtain first gyro gains; selecting a first target gyro gain according to first suppression rates respectively corresponding to the first gyro gains; searching for gyro gains within a second search range according to a second search step size less than the first search step size to obtain second gyro gains, the second search range being within the first search range, unequal to the first search range and having an intermediate value equal to the first target gyro gain; and selecting a second target gyro gain according to second suppression rates respectively corresponding to the second gyro gains. The search range and accuracy of gyro gains are well balanced to reduce search time.

### TECHNICAL FIELD

The present disclosure relates to the technical field of optical image stabilizers (OISs), and in particular, to a gyro gain search method and apparatus, an electronic device, and a storage medium.

### BACKGROUND

In recent years, in order to obtain a high-quality shooting effect, an optical image stabilizer (OIS) has been widely used in a camera module. The camera module with an OIS function is required to be calibrated before leaving the factory. A specific calibration process involves: searching for gyro gain (Gyro gain) within a preset search range; and converting, based on the found gyro gain, a gyro degree (Gyro degree) to a stroke position to which a motor is required to be moved when operating, i.e., to a current indication code value (Target Code) corresponding to a motor stroke. The gyro gain is defined as a medium for converting Gyro degree to Target Code, i.e., Target Code=Gyro degree*Gyro gain.

In the related art, a gyro gain search process includes: giving a search range and a search step size of gyro gains; making a gyro gain in an x-axis direction (referred to as x-axis gyro gains) equal to a gyro gain in a y-axis direction (referred to as y-axis gyro gains), both of which are equal to a lower threshold of the search range; taking a value obtained after addition of a current x-axis gyro gain to the search step size as a next x-axis gyro gain and taking a value obtained after addition of a current y-axis gyro gain to the search step size as a next y-axis gyro gain; . . . until a last x-axis gyro gain is greater than an upper threshold of the search range; calculating a suppression rate in the x-axis direction corresponding to each x-axis gyro gain (referred to as an x-axis suppression rate) and a suppression rate in the y-axis direction corresponding to each y-axis gyro gain (referred to as a y-axis suppression rate); and selecting the x-axis gyro gain corresponding to a maximum x-axis suppression rate and the y-axis gyro gain corresponding to a maximum y-axis suppression rate. So far, the search has been completed. Regarding the above search process, the search step size is unchanged, which is extremely time-consuming, and it is also difficult to balance the search range and the search accuracy of the gyro gains. If a more accurate gyro gain is to be obtained, the given search range and search step are acquired to be manually modified multiple times.

Therefore, there is a need to improve the above gyro gain search process.

### SUMMARY

An objective of the present disclosure is to provide a gyro gain search method and apparatus, an electronic device, and a storage medium, intended to solve the problem in the related art that it is difficult to balance the search range and the search accuracy of the gyro gains.

In an aspect, an embodiment of the present disclosure provides a gyro gain search method, including: searching for gyro gains within a first search range according to a first search step size, to obtain a plurality of first gyro gains; selecting a first target gyro gain from the plurality of first gyro gains according to first suppression rates respectively corresponding to the first gyro gains; searching for gyro gains within a second search range according to a second search step size, to obtain a plurality of second gyro gains, the second search range being within the first search range and not equal to the first search range, an intermediate value of the second search range being equal to the first target gyro gain, and the second search step size being less than the first search step size; and selecting a second target gyro gain from the plurality of second gyro gains according to second suppression rates respectively corresponding to the second gyro gains.

As an improvement, the searching for gyro gains within a first search range according to a first search step size, to obtain a plurality of first gyro gains includes: taking a first lower threshold of the first search range as a 1^{st} first gyro gain; and taking a value obtained after addition of the 1^{st} first gyro gain to the first search step size as a 2^{nd} first gyro gain; . . . until a last first gyro gain is greater than a first upper threshold of the first search range, the 1^{st} first gyro gain to a penultimate first gyro gain are all within the first search range.

As an improvement, the selecting a first target gyro gain from the plurality of first gyro gains according to first suppression rates respectively corresponding to the first gyro gains includes: calculating the first suppression rates respectively corresponding to the first gyro gains; comparing all the first suppression rates, to determine a first maximum suppression rate from all the first suppression rates based on a comparison result; and selecting the first target gyro gain corresponding to the first maximum suppression rate from all the first gyro gains.

As an improvement, the searching for gyro gains within a second search range according to a second search step size, to obtain a plurality of second gyro gains includes: taking a second lower threshold of the second search range as a 1^{st} second gyro gain; and taking a value obtained after addition of the 1^{st} second gyro gain to the second search step size as a 2^{nd} second gyro gain; . . . until a last second gyro gain is greater than a second upper threshold of the second search range, the 1^{st} second gyro gain to a penultimate second gyro gain being all within the second search range.

As an improvement, the selecting a second target gyro gain from the plurality of second gyro gains according to second suppression rates respectively corresponding to the second gyro gains includes: calculating the second suppression rates respectively corresponding to the second gyro gains; comparing all the second suppression rates, to determine a second maximum suppression rate from all the second suppression rates based on a comparison result; and selecting the second target gyro gain corresponding to the second maximum suppression rate from all the second gyro gains.

As an improvement, subsequent to the selecting a second target gyro gain from the plurality of second gyro gains, the method further includes: converting, according to the second target gyro gain and a preset conversion formula, a gyro degree into a current indication code value corresponding to a stroke position to which the motor is required to be placed when operating.

As an improvement, the conversion formula is expressed as Target Code=Gyro degree*Gyro gain, where Gyro gain denotes the second target gyro gain, Gyro degree denotes the gyro degree, and Target Code denotes the current indication code value.

In another aspect, an embodiment of the present disclosure provides a gyro gain search apparatus, including: a first search module configured to search for gyro gains within a first search range according to a first search step size, to obtain a plurality of first gyro gains; a first selection module configured to select a first target gyro gain from the plurality of first gyro gains according to first suppression rates respectively corresponding to the first gyro gains; a second search module configured to search for gyro gains within a second search range according to a second search step size, to obtain a plurality of second gyro gains, the second search range being within the first search range and not equal to the first search range, an intermediate value of the second search range is equal to the first target gyro gain, and the second search step size being less than the first search step size; and a second selection module configured to select a second target gyro gain from the plurality of second gyro gains according to second suppression rates respectively corresponding to each of the second gyro gains.

In another aspect, an embodiment of the present disclosure provides an electronic device, including: a memory configured to store at least one computer instruction; and a processor configured to invoke the at least one computer instruction to implement the gyro gain search method as described above.

In another aspect, an embodiment of the present disclosure provides a computer-readable storage medium. The computer-readable storage medium stores at least one computer instruction, and when the at least one computer instruction is invoked by a processor, the gyro gain search method as described above is implemented.

As can be known from the above description, compared with the related art, the present disclosure has the following beneficial effects. Firstly, gyro gains are searched for within a first search range according to a first search step size, and a first target gyro gain is selected from the plurality of first gyro gains found. Then, gyro gains are searched for within a second search range according to a second search step size, and a second target gyro gain is selected from the plurality of second gyro gains found. The second search range is within the first search range and is not equal to the first search range, an intermediate value of the second search range is equal to the first target gyro gain, and the second search step size is less than the first search step size. It can be understood that, in the present disclosure, firstly, a larger first search step size is used to conduct a preliminary search within a larger first search range (finally obtain a first target gyro gain), ensuring a search range of gyro gains, and then a smaller second search step size is used to conduct a further search near the first target gyro gain obtained by the preliminary search (that is, a smaller second search range, an intermediate value of which is equal to the first target gyro gain obtained by the preliminary search), ensuring search accuracy of the gyro gains. That is, in the present disclosure, the search range and the search accuracy of the gyro gains can be well balanced, and the search step size used during the search is not unchanged, which can effectively reduce search time.

### BRIEF DESCRIPTION OF DRAWINGS

In order to better illustrate the technical solutions in the related art or the embodiments of the present disclosure, the accompanying drawings used in the embodiments of the present disclosure will be briefly introduced below. It is apparent that, the accompanying drawings in the following description are merely some of rather than all of the embodiments of the present disclosure, and other drawings can be obtained by those of ordinary skill in the art from the provided drawings without creative efforts.

FIG. 1 is a schematic flowchart of a gyro gain search method according to some embodiments of the present disclosure;

FIG. 2 is a block diagram of modules of a gyro gain search apparatus according to some embodiments of the present disclosure;

FIG. 3 is a block diagram of modules of an electronic device according to some embodiments of the present disclosure; and

FIG. 4 is a block diagram of modules of a computer-readable storage medium according to some embodiments of the present disclosure.

### DESCRIPTION OF EMBODIMENTS

In order to make the objectives, technical solutions, and advantages of the present disclosure more understandable, the present disclosure will be described below with reference to the embodiments of the present disclosure and the corresponding accompanying drawings. Same or similar reference numerals indicate same or similar components or components having the same or similar functions. It should be understood that various embodiments of the present disclosure described below are only intended to explain the present disclosure and are not intended to limit the present disclosure. That is, based on the various embodiments of the present disclosure, all other embodiments obtained by those of ordinary skill in the art without creative efforts fall within the protection scope of the present disclosure. In addition, the technical features involved in the various embodiments of the present disclosure described below may be combined with each other as long as they do not conflict with each other.

In the related art, a gyro gain search is generally conducted in directions of orthogonal x and y axes through a cross graph. A specific process involves: giving a search range and a search step size of gyro gains; making a gyro gain in an x-axis direction (x-axis gyro gain) equal to a gyro gain in a y-axis direction (y-axis gyro gain), both of which are equal to a lower threshold of the search range; taking a value obtained after addition of a current x-axis gyro gain to the search step size as a next x-axis gyro gain and taking a value obtained after addition of a current y-axis gyro gain to the search step size as a next y-axis gyro gain; . . . until a last x-axis gyro gain is greater than an upper threshold of the search range; calculating a suppression rate in the x-axis direction corresponding to each x-axis gyro gain (x-axis suppression rate) and a suppression rate in the y-axis direction corresponding to each y-axis gyro gain (y-axis suppression rate); and selecting the x-axis gyro gain corresponding to a maximum x-axis suppression rate and the y-axis gyro gain corresponding to a maximum y-axis suppression rate. Regarding the above search process, the search step size is unchanged, which is extremely time-consuming, and it is also difficult to balance the search range and the search accuracy of the gyro gains. If a more accurate gyro gain is to be obtained, the given search range and search step are acquired to be manually modified multiple times. To this end, in the embodiments of the present disclosure, a gyro gain search method is provided in the present disclosure. In this method, the search range and the search accuracy of the gyro gains can be well balanced, and the search step size used during the search is not unchanged, which can effectively reduce search time.

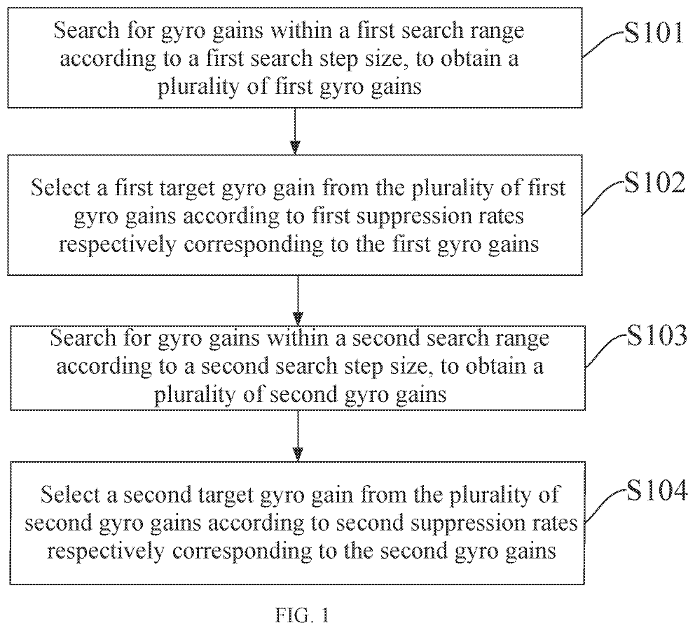

FIG. 1 is a schematic flowchart of a gyro gain search method according to some embodiments of the present disclosure. In some embodiments, the gyro gain search method includes four steps S101 to S104.

In S101, gyro gains are searched for within a first search range according to a first search step size, and a plurality of first gyro gains are obtained.

In these embodiments, there is a need to preset the first search range of the gyro gains and the corresponding first search step size, so as to search for the gyro gains within the first search range according to the first search step size to finally obtain the plurality of first gyro gains. Exemplarily, the first search range is set to [100, 1000], that is, a search is conducted from 100 to 1000. At the same time, the first search step size is set to 50, that is, a respective first gyro gain is determined every 50. Then, several first gyro gains can be determined within the first search range of [100, 1000].

In an embodiment, S101 includes: taking a first lower threshold of the first search range as a 1^{st} first gyro gain; and taking a value obtained after addition of the 1^{st} first gyro gain to the first search step size as a 2^{nd} first gyro gain; . . . until a last first gyro gain is greater than a first upper threshold of the first search range. In this case, the 1^{st} first gyro gain to a penultimate first gyro gain are all within the first search range, while the last first gyro gain is outside the first search range. It can be understood that, in this embodiment, when the first gyro gains are searched for in the first search range, the first lower threshold of the first search range is taken as the 1^{st} first gyro gain, that is, the 1^{st} first gyro gain is 100, then the value obtained after addition of the 1^{st} first gyro gain to the first search step size is taken as the 2^{nd} first gyro gain, that is, the 2^{nd} first gyro gain is 100+50=150, and so on, until the last first gyro gain is greater than the first upper threshold of the first search range, that is, the last first gyro gain is 1050.

In S102, a first target gyro gain is selected from the plurality of first gyro gains according to first suppression rates respectively corresponding to the first gyro gains.

In these embodiments, after the plurality of first gyro gains are obtained through S101, there is a need to further select the first target gyro gain from the plurality of first gyro gains according to the first suppression rates respectively corresponding to the first gyro gains. In an embodiment, S102 includes: calculating the first suppression rates respectively corresponding to the first gyro gains; comparing all the first suppression rates, and determining a first maximum suppression rate from all the first suppression rates based on a comparison result; and selecting the first target gyro gain corresponding to the first maximum suppression rate from all the first gyro gains. It can be understood that, in this embodiment, when the first target gyro gain is selected, the selection is based on the suppression rate. That is, the first suppression rates respectively corresponding to the first gyro gains are determined first, and then the first target gyro gain with the maximum first suppression rate is selected from all the first gyro gains. In addition, it is to be noted that the suppression rate (SR) in the embodiments of the present disclosure may also be called a suppression ratio.

In S103, gyro gains are searched for within a second search range according to a second search step size, to obtain a plurality of second gyro gains.

In these embodiments, after the first target gyro gain is selected from the plurality of first gyro gains, there is a need to further search for gyro gains within the second search range according to the second search step size and to finally obtain the plurality of second gyro gains. The second search range is within the first search range and is not equal to the first search range, an intermediate value of the second search range is equal to the first target gyro gain, and the second search step size is less than the first search step size.

It can be understood that, since the second search range is within the first search range and is not equal to the first search range and the intermediate value of the second search range is equal to the first target gyro gain, S103 is actually conducting a second search near the first target gyro gain obtained in S102. That is, a purpose of acquiring the first target gyro gain through S101 and S102 is actually to serve S103 and subsequent S104. Exemplarily, assuming that the first target gyro gain obtained in S102 is 500, the second search may be conducted within values of 50 near the first target gyro gain. That is, the second search range is [450, 550]. At the same time, the second search step size may be set to 20, that is, a respective second gyro gain is determined every 20. Then, several second gyro gains may be determined within the second search range of [450, 550].

In an embodiment, S103 includes: taking a second lower threshold of the second search range as a 1^{st} second gyro gain; and taking a value obtained after addition of the 1^{st} second gyro gain to the second search step size as a 2^{nd} second gyro gain; . . . until a last second gyro gain is greater than a second upper threshold of the second search range. In this case, the 1^{st} second gyro gain to a penultimate second gyro gain are all within the second search range, while the last second gyro gain is outside the second search range. It can be understood that, in this embodiment, when the second gyro gains are searched for within the second search range, the second lower threshold of the second search range is taken as the 1^{st} second gyro gain, that is, the 1^{st} second gyro gain is 450, then the value obtained after addition of the 1^{st} second gyro gain to the second search step size is taken as the 2^{nd} second gyro gain, that is, the 2^{nd} second gyro gain is 450+20=470, and so on, until the last second gyro gain is greater than the second upper threshold of the second search range, that is, the last second gyro gain is 570.

In S104, a second target gyro gain is selected from the plurality of second gyro gains according to second suppression rates respectively corresponding to the second gyro gains.

In these embodiments, after the plurality of second gyro gains are obtained through S103, there is a need to further select the second target gyro gain from the plurality of second gyro gains according to the second suppression rates respectively corresponding to the second gyro gains. In an embodiment, S104 includes: calculating the second suppression rates respectively corresponding to the second gyro gains; comparing all the second suppression rates, and determining a second maximum suppression rate from all the second suppression rates based on a comparison result; and selecting the second target gyro gain corresponding to the second maximum suppression rate from all the second gyro gains. It can be understood that, in this embodiment, when the second target gyro gain is selected, the selection is based on the suppression rate. That is, the second suppression rates respectively corresponding to the second gyro gains are determined first, and then the second target gyro gain with the maximum second suppression rate is selected from all the second gyro gains.

As can be seen through S101 to S104 above, in the embodiments of the present disclosure, firstly, a larger first search step size is used to conduct a preliminary search within a larger first search range (finally obtain a first target gyro gain), ensuring a search range of gyro gains; and then, a smaller second search step size is used to conduct a further search near the first target gyro gain obtained by the preliminary search (that is, a smaller second search range, an intermediate value of which is equal to the first target gyro gain obtained by the preliminary search), ensuring search accuracy of the gyro gains. That is, according to the embodiments of the present disclosure, the search range and the search accuracy of the gyro gains can be well balanced, and the search step size used during the search is not unchanged, which can effectively reduce search time.

The above embodiments are merely preferred implementations of the present disclosure, which are not the only limitations to the described content. In this regard, those skilled in the art can make flexible settings according to actual application scenes based on the above embodiments. In addition, it is to be noted that during the OIS calibration, in addition to searching for the gyro gains and determining the final gyro gain, there is a need to further use the final gyro gain to convert a gyro degree into a current indication code value corresponding to a stroke position to which a motor is required to be placed when operating. Therefore, in the embodiments of the present disclosure, after the second target gyro gain is obtained, that is, after S104, the method may further include: converting, according to the second target gyro gain and a preset conversion formula, a gyro degree into a current indication code value corresponding to a stroke position to which the motor is required to be placed when operating. For example, the conversion formula may be expressed as: Target Code Gyro degree*Gyro gain, where Gyro gain denotes the second target gyro gain, Gyro degree denotes the gyro degree, and Target Code denotes the current indication code value. It is to be further noted that, consistent with the conventional solution, the gyro gains and the suppression rates in the embodiments of the present disclosure include values in x-axis and y-axis directions. In this case, when gyro gains are searched for within a search range, actually, a lower threshold of the search range is taken as a first x-axis gyro gain and a first y-axis gyro gain, then values obtained after addition of the first x-axis gyro gain and the first y-axis gyro gain to search step sizes respectively are taken as a second x-axis gyro gain and a second y-axis gyro gain, and so on. At the same time, when a target gyro gain is selected from a plurality of gyro gains found, actually two target gyro gains are selected, namely an x-axis target gyro gain and a y-axis target gyro gain.

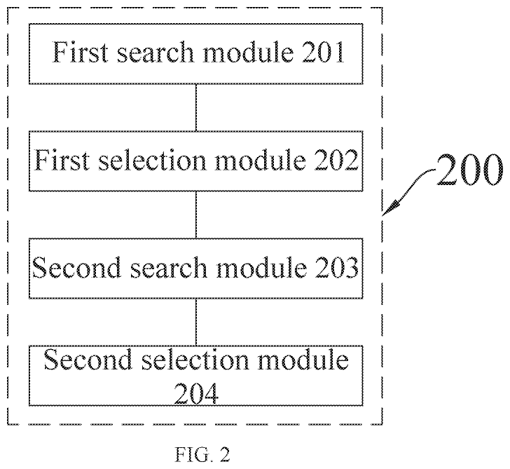

FIG. 2 is a block diagram of modules of a gyro gain search apparatus according to some embodiments of the present disclosure. In some embodiments, a gyro gain search apparatus 200 includes a first search module 201, a first selection module 202, a second search module 203, and a second selection module 204. In practical applications, the first search module 201 may search for gyro gains within a first search range according to a first search step size, to obtain a plurality of first gyro gains; the first selection module 202 may select a first target gyro gain from the plurality of first gyro gains according to first suppression rates respectively corresponding to the first gyro gains; the second search module 203 may search for gyro gains within a second search range according to a second search step size, to obtain a plurality of second gyro gains, wherein the second search range is within the first search range and is not equal to the first search range, an intermediate value of the second search range is equal to the first target gyro gain, and the second search step size is less than the first search step size; and the second selection module 204 may select a second target gyro gain from the plurality of second gyro gains according to second suppression rates respectively corresponding to the second gyro gains.

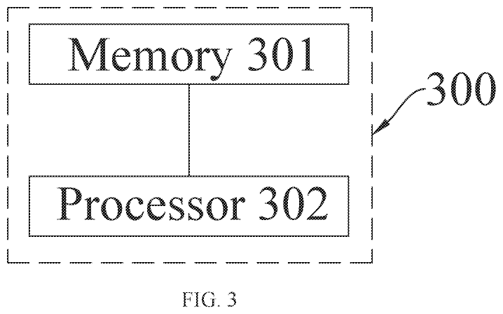

FIG. 3 is a block diagram of modules of an electronic device according to some embodiments of the present disclosure. In some embodiments, an electronic device 300 includes a memory 301 and a processor 302. The memory 301 stores at least one computer instruction, and the processor 302 may invoke the at least one computer instruction stored in the memory 301 to implement the foregoing gyro gain search method.

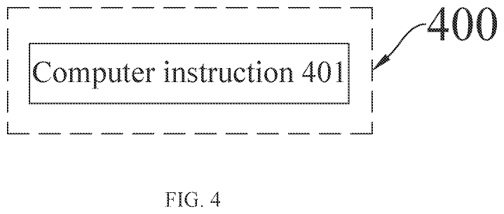

FIG. 4 is a block diagram of modules of a computer-readable storage medium according to some embodiments of the present disclosure. In some embodiments, a computer-readable storage medium 400 stores at least one computer instruction 401, and when the at least one computer instruction 401 is invoked by a processor 302, the foregoing gyro gain search method may be implemented.

The steps in the method or algorithm described in the embodiments disclosed herein may be implemented directly by hardware, a software module executed by a processor, or a combination thereof. The software module may reside in a random access memory (RAM), an internal memory, a read-only memory (ROM), an electrically programmable ROM, an electrically erasable programmable ROM, a register, a hard disk, a removable disk, a CD-ROM, or any other form of storage medium well known in the art.

The above embodiments may be implemented entirely or partially by software, hardware, firmware, or any combination thereof. When implemented by software, the embodiments may be implemented entirely or partially in a form of a computer program product. The computer program product includes one or more computer instructions. When the computer program instructions are loaded and executed on a computer, the procedures or functions according to the present disclosure are all or partially generated. The computer may be a general-purpose computer, a dedicated computer, a computer network, or other programmable apparatuses. The computer instructions may be stored in a computer-readable storage medium or may be transmitted from one computer-readable storage medium to another computer-readable storage medium. For example, the computer instructions may be transmitted from a website, computer, server, or data center to another website, computer, server, or data center in a wired (such a (DSL)) or wireless (such as infrared, radio, or microwave) manner. The computer-readable storage medium may be any available medium accessible to a computer, or a data storage device, such as a server or a data center, integrating one or more usable media. The available medium may be a magnetic medium (such as a floppy disk, a hard disk, or a magnetic tape), an optical medium (such as a DVD), a semiconductor medium (such as a solid-state drive (SSD)), or the like.

It is to be noted that various embodiments in the content of the present disclosure are described in a progressive manner, and each embodiment focuses on its difference from other embodiments. Same and similar parts of the various embodiments can be referred to each other. Product embodiments are similar to method embodiments, and therefore the description thereof is relatively simple. For relevant details, please refer to the related description of the method embodiments.

It is to be further noted that relational terms such as (1^{st}) first and (2^{nd}) second in the present disclosure are only used to distinguish one entity or operation from another entity or operation, and do not necessarily require or imply existence of an actual relationship or sequence between such entities or operations. Moreover, the terms such as “comprise”, “include”, and any variants thereof are intended to cover a non-exclusive inclusion, so that a process, method, item, or device including a series of elements includes not only those elements but also other elements not expressly listed or elements inherent to the process, method, item, or device. Without further limitation, an element defined by the statement “comprising/including a/an . . . ” does not exclude the presence of additional identical elements in the process, method, item, or device that includes the stated element.

The above description of the disclosed embodiments enables those skilled in the art to implement or use the content of the present disclosure. Various modifications to these embodiments will be readily apparent to those skilled in the art. The general principles defined in the present disclosure may be implemented in other embodiments without departing from the spirit or scope of the present disclosure. Therefore, the present disclosure is not intended to be limited to the embodiments shown in the present disclosure but extends to the widest scope that complies with the principles and novel features disclosed in the present disclosure.

What is claimed is:

1. A gyro gain search method, comprising:
searching for gyro gains within a first search range according to a first search step size, to obtain a plurality of first gyro gains;
selecting a first target gyro gain from the plurality of first gyro gains according to first suppression rates respectively corresponding to the first gyro gains;
searching for gyro gains within a second search range according to a second search step size, to obtain a plurality of second gyro gains, wherein the second search range is within the first search range and is not equal to the first search range, an intermediate value of the second search range is equal to the first target gyro gain, and the second search step size is less than the first search step size; and
selecting a second target gyro gain from the plurality of second gyro gains according to second suppression rates respectively corresponding to the second gyro gains.

2. The gyro gain search method as described in claim 1, wherein the searching for gyro gains within a first search range according to a first search step size, to obtain a plurality of first gyro gains comprises:
taking a first lower threshold of the first search range as a 1^{st} first gyro gain; and
taking a value obtained after addition of the 1^{st} first gyro gain to the first search step size as a 2^{nd} first gyro gain; . . . until a last first gyro gain is greater than a first upper threshold of the first search range, wherein the 1^{st} first gyro gain to a penultimate first gyro gain are all within the first search range.

3. The gyro gain search method as described in claim 1, wherein the selecting a first target gyro gain from the plurality of first gyro gains according to first suppression rates respectively corresponding to the first gyro gains comprises:
calculating the first suppression rates respectively corresponding to the first gyro gains;
comparing all the first suppression rates, to determine a first maximum suppression rate from all the first suppression rates based on a comparison result; and
selecting the first target gyro gain corresponding to the first maximum suppression rate from all the first gyro gains.

4. The gyro gain search method as described in claim 1, wherein the searching for gyro gains within a second search range according to a second search step size, to obtain a plurality of second gyro gains comprises:
taking a second lower threshold of the second search range as a 1^{st} second gyro gain; and
taking a value obtained after addition of the 1^{st} second gyro gain to the second search step size as a 2^{nd} second gyro gain; . . . until a last second gyro gain is greater than a second upper threshold of the second search range, wherein the 1^{st} second gyro gain to a penultimate second gyro gain are all within the second search range.

5. The gyro gain search method as described in claim 1, wherein the selecting a second target gyro gain from the plurality of second gyro gains according to second suppression rates respectively corresponding to the second gyro gains comprises:
calculating the second suppression rate respectively corresponding to the second gyro gains;
comparing all the second suppression rates, to determine a second maximum suppression rate from all the second suppression rates based on a comparison result; and
selecting the second target gyro gain corresponding to the second maximum suppression rate from all the second gyro gains.

6. The gyro gain search method as described in claim 1, subsequent to the selecting a second target gyro gain from the plurality of second gyro gains, further comprising:
converting, according to the second target gyro gain and a preset conversion formula, a gyro degree into a current indication code value corresponding to a stroke position to which the motor is required to be placed when operating.

7. The gyro gain search method as described in claim 6, wherein the conversion formula is expressed as Target Code=Gyro degree*Gyro gain, where Gyro gain denotes the second target gyro gain, Gyro degree denotes the gyro degree, and Target Code denotes the current indication code value.

8. A gyro gain search apparatus, comprising:
a first search module configured to search for gyro gains within a first search range according to a first search step size, to obtain a plurality of first gyro gains;
a first selection module configured to select a first target gyro gain from the plurality of first gyro gains according to first suppression rates respectively corresponding to the first gyro gains;
a second search module configured to search for gyro gains within a second search range according to a second search step size, to obtain a plurality of second gyro gains, wherein the second search range is within the first search range and is not equal to the first search range, an intermediate value of the second search range is equal to the first target gyro gain, and the second search step size is less than the first search step size; and
a second selection module configured to select a second target gyro gain from the plurality of second gyro gains according to second suppression rates respectively corresponding to the second gyro gains.

9. A computer-readable storage medium, wherein the computer-readable storage medium stores at least one computer instruction, and when the at least one computer instruction is invoked by a processor, the gyro gain search method as described in claim 1 is implemented.
